(19) United States
(12) Patent Application Publication
(10) Pub. No.: US 2015/0172587 A1
(43) Pub. Date: Jun. 18, 2015

(54) DISPLAY DEVICE, DISPLAY METHOD AND DISPLAY PROGRAM

(71) Applicants: Kabushiki Kaisha Toshiba, Tokyo (JP); Toshiba Lifestyle Products & Services Corporation, Tokyo (JP)

(72) Inventor: Michiyo Morimoto, Fuchu Tokyo (JP)

(21) Appl. No.: 14/630,464

(22) Filed: Feb. 24, 2015

Related U.S. Application Data
(63) Continuation of application No. PCT/JP2013/078781, filed on Oct. 24, 2013.

(51) Int. Cl. H04N 5/445

(52) U.S. Cl. CPC H04N 5/445

(57) ABSTRACT

There is provided a display device, a display method and a display program capable of easily controlling a sub-screen. According to an embodiment, the display device is provided, including a display unit capable of displaying a sub-screen at a part, and a display control unit that, in response to an operation performed to a first key in a remote controller, displays the sub-screen at an initial position which is a part of the display unit in the case that the sub-screen is not displayed on the display unit, and displays the sub-screen at a different position or hides the sub-screen in the case that the sub-screen is displayed at a part of the display unit.

### CROSS-REFERENCE TO RELATED APPLICATIONS

This application is based upon and claims the benefit of priority from the prior PCT Patent Application No. PCT/JP2013/078781, filed on Oct. 24, 2013, the entire contents of which are incorporated herein by reference.

### TECHNICAL FIELD

Embodiments of the present invention relate to a display device, a display method and a display program.

### BACKGROUND ART

As a display device becomes highly functional, it is becoming possible to display not only contents from broadcasting waves but also a webpage on a display. Then, users often demand to view the contents while browsing the webpage. Accordingly, a display device having a so-called PIP (Picture In Picture) function that, while displaying the webpage on the entire display, displays contents at a part thereof as a sub-screen is widely known.

Now, when a sub-screen is displayed on the webpage, a part of the webpage is hidden by the sub-screen and cannot be browsed. Controlling the sub-screen so as to allow the hidden part to be browsed often involves an operation that takes time and labor.

### CITATION LIST

### Patent Literature

### Patent Literature 1: Japanese Patent Laid-Open No. 2006-236335

### Patent Literature 2: National Publication of International Patent Application No. 2013-524684

### Patent Literature 3: National Publication of International Patent Application No. 2002-515207

### SUMMARY OF INVENTION

### Technical Problem

A display device, a display method and a display program capable of easily controlling a sub-screen will be provided.

### Solution to Problem

According to an embodiment, there is provided an electronic apparatus including a display configured to display a main-screen for displaying a web page and a sub-screen for displaying a content, wherein a display area of the main-screen and a display area of the sub-screen are at least partially overlapped; and circuitry configured to display the sub-screen at a first area on the display when the sub-screen is not displayed on the display at a timing of an operation to a first key in a remote controller, and configured to change a display position of the sub-screen or hide the sub-screen when the sub-screen is displayed on the display at a timing of an operation to the first key in the remote controller.

### BRIEF DESCRIPTION OF DRAWINGS

FIG. 1 is an exterior view of a display device 100 according to one embodiment.

FIG. 2 is a block diagram illustrating one example of a general configuration of a controller 5.

FIG. 3 is an exterior view of a remote controller 10 that controls the display device 100.

FIG. 4 is a diagram illustrating one example of a main GUI screen.

FIG. 5 is a diagram illustrating a state that a sub-screen 13 is displayed at lower right.

FIG. 6 is a diagram illustrating a state that the sub-screen 13 is displayed at lower left.

FIG. 7 is a diagram illustrating a state that the sub-screen 13 is displayed at upper left.

FIG. 8 is a diagram illustrating a state that the sub-screen 13 is displayed at upper right.

FIG. 9 is a block diagram illustrating a configuration of a display device 100 used for sub-screen control.

FIG. 10 is a flowchart illustrating one example of a processing operation of a signal processor 120 in the case that a red key 10R is depressed.

### DESCRIPTION OF EMBODIMENTS

Hereinafter, an embodiment will be specifically described with reference to the drawings.

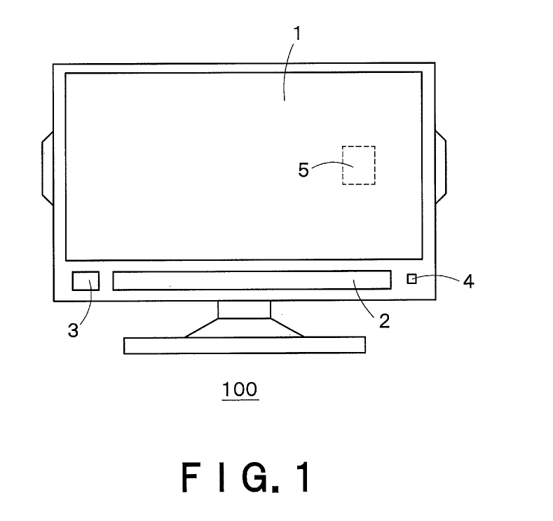

FIG. 1 is an exterior view of a display device (electronic apparatus) 100 according to one embodiment. The display device 100 includes a display unit 1, a speaker 2, a light receiver (control signal receiving unit) 3, an operating unit 4, and a controller 5.

The display unit 1 is a liquid crystal display, and displays various images such as a webpage and contents. Also, a master screen can be displayed at the entire display unit 1, and a sub-screen can be displayed at a part of the display unit 1. When the sub-screen is displayed on the master screen, a part of the master screen is hidden by the sub-screen. Therefore, a user cannot view a hidden portion. A display unit 1 is configured to display a main-screen for displaying a web page and a sub-screen for displaying a content. A display area of the main-screen and a display area of the sub-screen are at least partially overlapped.

The speaker 2 reproduces sound. The speaker 2 may reproduce sound according to an image displayed on the display unit 1, or may be able to reproduce sound unrelated to the image.

The light receiver 3 receives control signals from a remote controller that controls the display device 100. In the case that the remote controller emits infrared ray signals as the control signals, the light receiver 3 is configured by a photodiode that reacts to infrared rays. As one example, the light receiver 3 receives the control signals for displaying, moving or hiding the sub-screen. Also, the control signals from the remote controller are not limited to the infrared ray signals and may be the control signals by wireless or cable communication.

The operating unit 4 is one or a plurality of buttons provided on a main body of the display device 100. As one example, the operating unit 4 can include a button for turning a power source of the display device 100 on/off or a button for adjusting a sound volume. Or, the operating unit 4 may include a button for displaying, moving or hiding the sub-screen. When the button in the operating unit 4 is depressed, an operation signal according to the depressed button is generated.

The controller 5 is provided on a back surface of the display device 100 for example, and processes video signals inputted from the outside, performs communication, and controls the image displayed on the display unit 1.

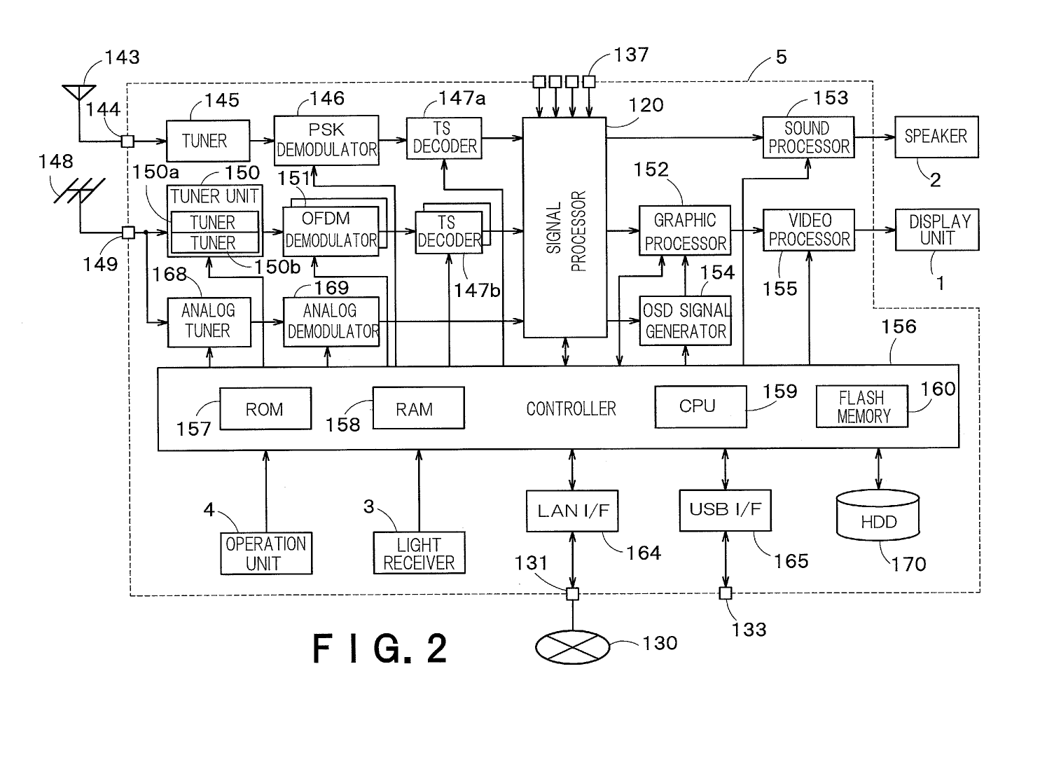

FIG. 2 is a block diagram illustrating one example of a general configuration of the controller 5. The controller 5 includes a controller 156 that controls operations of the individual units. The controller 156 includes a ROM (Read Only Memory) 157, a RAM (Random Access Memory) 158, a CPU (Central Processing Unit) 159, and a flash memory 160.

The controller 156 activates a system control program and various kinds of processing programs stored in the ROM 157 beforehand according to the operation signals inputted from the operating unit 4 or the control signals transmitted from the remote controller and inputted through the light receiver 3. The controller 156 turns the RAM 158 to a work memory of the CPU 159, and controls the operations of the individual units according to the activated program. Also, the controller 156 stores information or the like needed for various kinds of setting in the flash memory 160 which is a nonvolatile memory like a NAND flash memory for example and uses it.

Also, the controller 5 includes an input terminal 144 to which signals are inputted from an antenna 143, a tuner 145, a PSK (Phase Shift Keying) demodulator 146, a TS (Transport Stream) decoder 147a, and a signal processor 120.

The input terminal 144 transmits digital satellite television broadcasting signals received by the antenna 143 for receiving BS/CS digital broadcasting to the tuner 145 for digital satellite broadcasting. The tuner 145 tunes the received digital broadcasting signals, and transmits the tuned digital broadcasting signals to the PSK demodulator 146. The PSK demodulator 146 demodulates TS from the digital broadcasting signals, and transmits the demodulated TS to the TS decoder 147a. The TS decoder 147a decodes the TS into digital signals including digital video signals, digital sound signals, and data signals, and then transmits them to the signal processor 120.

The digital video signals here are digital signals related to video images that the controller 5 can output, and the digital sound signals are digital signals related to sound that the controller 5 can output. Also, the data signals are digital signals indicating various kinds of information on demodulated services.

Also, the controller 5 includes an input terminal 149 to which signals are inputted from an antenna 148, a tuner unit 150 having two tuners 150a and 150b, two OFDM (Orthogonal Frequency Division Multiplexing) demodulators 151, two TS decoders 147b, an analog tuner 168, and an analog demodulator 169.

The input terminal 149 transmits digital terrestrial television broadcasting signals received by the antenna 148 for receiving terrestrial digital broadcasting to the tuner unit 150 for digital terrestrial broadcasting. The tuners 150a and 150b of the tuner unit 150 tune the received digital broadcasting signals respectively, and transmit the tuned digital broadcasting signals to the two existing OFDM demodulators 151. The OFDM demodulators 151 demodulate the TS from the digital broadcasting, and transmit the demodulated TS to the corresponding TS decoders 147b respectively. The TS decoders 147b decode the TS into digital video signals and sound signals or the like, and then transmit them to the signal processor 120. The digital terrestrial television broadcasting acquired in each of the tuners 150a and 150b of the tuner unit 150 can be decoded as the digital signals including the digital video signals, the digital sound signals and the data signals respectively and simultaneously by two each of the OFDM demodulators 151 and the TS decoders 147b and then transmitted to the signal processor 120.

The antenna 148 can also receive analog terrestrial television broadcasting signals. The received analog terrestrial television broadcasting signals are distributed by a distributor not shown in the figure, and transmitted to the analog tuner 168. The analog tuner 168 tunes the received analog broadcasting signals, and transmits the tuned analog broadcasting signals to the analog demodulator 169. The analog demodulator 169 demodulates the analog broadcasting signals, and transmits the demodulated analog broadcasting signals to the signal processor 120. Also, the controller 5 can allow viewing of CATV (Common Antenna Television) by connecting a tuner for the CATV to the input terminal 149 to which the antenna 148 is connected, as one example.

Also, the controller 5 includes a line input terminal 137, a sound processor 153, a graphic processor 152, an OSD (On Screen Display) signal generator 154, and a video processor 155.

The line input terminal 137 receives input signals from an external reproducing device (an optical disk reproducing device or the like) through an HDMI cable or the like.

The signal processor 120 executes appropriate signal processing to the digital signals transmitted from the TS decoders 147a and 147b or the controller 156. More specifically, the signal processor 120 separates the digital signals into the digital video signals, the digital sound signals, and the data signals. The separated digital video signals are transmitted to the graphic processor 152, and the sound signals are transmitted to the sound processor 153. Also, the signal processor 120 converts the broadcasting signals transmitted from the analog demodulator 169 to the video signals and sound signals of a prescribed digital format. The video signals converted to the digital signals are transmitted to the graphic processor 152, and the sound signals are transmitted to the sound processor 153. Also, the signal processor 120 executes prescribed digital signal processing to the input signals from the line input terminal 137 as well.

The sound processor 153 converts the inputted sound signals to analog sound signals of a format that can be reproduced in the speaker 2. The analog sound signals are transmitted to the speaker 2 and reproduced.

The OSD signal generator 154 generates OSD signals for displaying a UI (user interface) screen or the like according to control of the controller 156. Also, the data signals separated from the digital broadcasting signals in the signal processor 120 are converted to the OSD signals of a more appropriate format by the OSD signal generator 154, and transmitted to the graphic processor 152.

The graphic processor 152 performs decoding processing of the digital video signals transmitted from the signal processor 120. The decoded video signals are superimposed and combined with the OSD signals transmitted from the OSD signal generator 154, and transmitted to the video processor 155. The graphic processor 152 can also selectively transmit the decoded video signals or the OSD signals to the video processor 155.

The video processor 155 converts the signals transmitted from the graphic processor 152 to analog video signals of a format that can be displayed on the display unit 1. The analog video signals are transmitted to the display unit 1 and displayed.

Further, the controller 5 includes a LAN (Local Area Network) terminal 131, a LAN I/F (Interface) 164, a USB (Universal Serial Bus) terminal 133, a USB I/F 165, and an HDD (Hard Disk Drive) 170.

The LAN terminal 131 is connected to the controller 156 through the LAN I/F 164. The LAN terminal 131 is used as a general LAN corresponding port using Ethernet (R). In the present embodiment, a LAN cable is connected to the LAN terminal 131, and it is possible to communicate with the Internet 130.

The USB terminal 133 is connected to the controller 156 through the USB I/F 165. The USB terminal 133 is used as a general USB corresponding port. To the USB terminal 133, for example, a cellular phone, a digital camera, a card reader/writer for various kinds of memory cards, an HDD, and a keyboard or the like are connected through a hub. The controller 156 can communicate (transmit and receive) information with devices connected through the USB terminal 133.

The HDD 170 is a magnetic storage medium built in the controller 5, and has a function of storing various kinds of information that the controller 5 has.

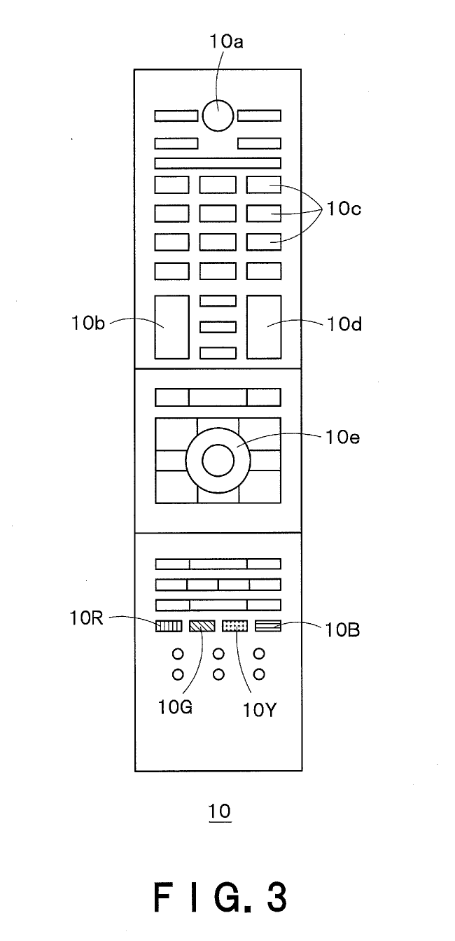

FIG. 3 is an exterior view of a remote controller 10 that controls the display device 100. The remote controller 10 is provided with a power key 10a, a sound volume adjusting key 10b, channel selecting keys 10c, a channel switching key 10d, an arrow key 10e, and the like. Further, the remote controller 10 is provided with, as color keys, a red key 10R, a green key 10G, a yellow key 10Y and a blue key 10B in order from the left. Examples of roles of these color keys will be described later.

When a user depresses the power key 10a of the remote controller 10, the display device 100 is activated. Then, the controller 156 in FIG. 2 generates a main GUI screen, and the main GUI screen is displayed on the display unit 1 as a main screen.

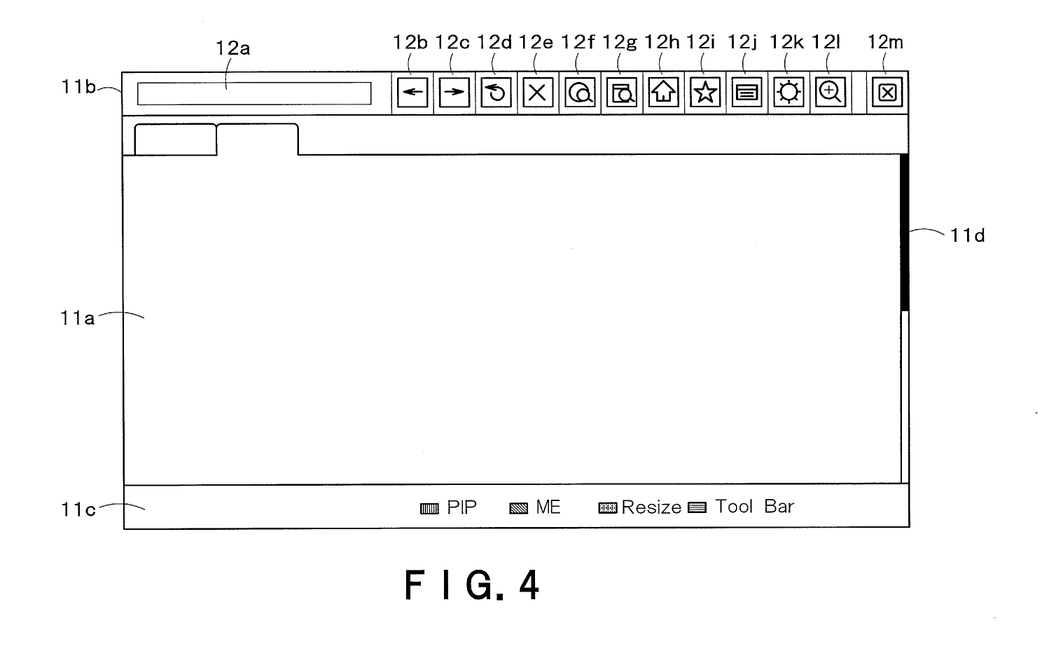

FIG. 4 is a diagram illustrating one example of the main GUI screen. The main GUI screen includes a web content area 11a, a tool bar area 11b, a help guide area 11c, and a position bar 11d.

In the web content area 11a, an image of the webpage acquired by the LAN I/F 164 in FIG. 2 is displayed. The plurality of webpages may be switched and displayed in a tab format.

In the tool bar area 11b, icons below or the like are displayed.

In an address bar 12a, an URL of a currently displayed webpage is displayed. A back icon 12b is an icon for, in the case that there is a different webpage opened before opening the currently displayed webpage, returning to the different webpage. A forward icon 12c is an icon for, in the case that there is a different webpage opened after opening the currently displayed webpage, advancing to the different webpage.

A refresh icon 12d is an icon for updating the currently displayed webpage. A stop icon 12e is an icon for stopping loading of the webpage that is being loaded.

A search icon 12f is an icon for searching a webpage. More specifically, when the search icon 12f is selected, a field for inputting text data is displayed. A user can input arbitrary text data to the field using the remote controller 10. On the basis of the inputted text data, the webpage is searched.

A find-in-page icon 12g is an icon for finding a prescribed keyword from the currently displayed webpage. More specifically, when the find-in-page icon 12g is selected, a field for inputting text data is displayed. A user can input arbitrary text data to the field using the remote controller 10. From the currently displayed webpage, the inputted text data is found.

A home icon 12h is an icon for displaying a predetermined home webpage. When a bookmark icon 12i is selected, a bookmark screen is displayed, and one of the webpages registered beforehand can be selected. When a history icon 12j is selected, a history screen is displayed, and one of the browsed webpages can be selected again.

A setting icon 12k is an icon for performing various kinds of setting for the main GUI screen or the like. That is, when the setting icon 12k is selected, a setting screen for performing the setting is displayed. A zoom icon 12l is an icon for enlarging the currently displayed webpage. An exit icon 12m is an icon for closing the currently displayed webpage.

In the help guide area 11c, simple descriptions for main keys of the remote controller 10 are displayed.

For example, the red key 10R is a PIP (Picture In Picture) key, and it is indicated that the sub-screen is to be controlled when the red key 10R is depressed. As one of features of the present embodiment, when the red key 10R is depressed in a state that the sub-screen is not displayed, the sub-screen is displayed at a certain initial position (first area). When the red key 10R is depressed in the state that the sub-screen is displayed, the sub-screen is moved and displayed at a different position, or the sub-screen is hidden. In this way, in the present embodiment, display, movement and hiding of the sub-screen are allocated to one red key 10R. This point will be described in detail later.

Also, in the help guide area 11c, it is indicated that the green key 10G is a switch to a mouse emulation key. That is, when the green key 10G is depressed, a cursor on the main GUI screen can be arbitrarily moved using the arrow key 10e of the remote controller 10 like a mouse. When the green key 10G is depressed again, it is switched to a navigation key, and a link destination inside the webpage is moved by the arrow key 10e of the remote controller 10. By depressing the green key 10G, an operation of the arrow key of the remote controller 10 is switched.

Further, it is indicated that the yellow key 10Y is a key that adjusts (resizes) a size of the sub-screen. That is, when the yellow key 10Y is depressed, the size of the sub-screen is enlarged or reduced.

Then, it is indicated that the blue key 10B is a moving key for selecting the tool bar area 11b. When the blue key 10B is depressed again, movement into the webpage is made. By depressing the blue key 10B, the movement is made alternately between the tool bar area 11b and a position inside the webpage.

The position bar 11d indicates a position of the currently displayed webpage. By moving the position bar 11d, the webpage can be scrolled.

Subsequently, an outline of sub-screen display in the present embodiment will be described. The sub-screen is displayed at a part of the display unit 1, and its display position is predetermined. More specifically, the plurality of display positions that are different from each other are set at the display unit 1.

It is defined that the display positions in the present embodiment are lower right, lower left, upper left, and upper right of the display unit 1. Also, as described above, the red key 10R is allocated for controlling the sub-screen. As illustrated in FIG. 3, the red key 10R is at a left end of the remote controller 10. In this way, by allocating a key arranged at an end for controlling the sub-screen, operability of a user can be improved.

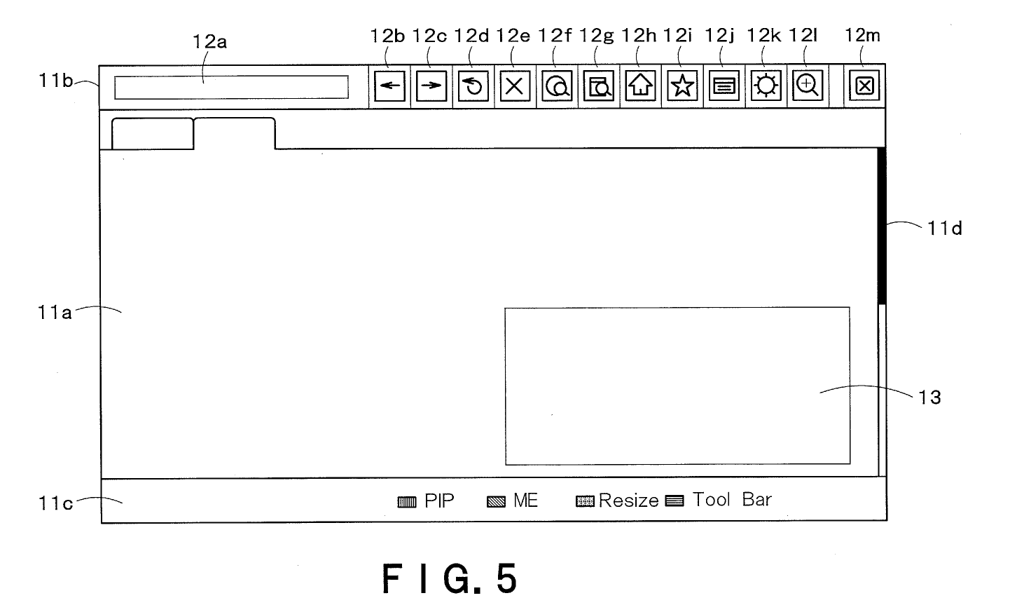

In the case that the main GUI screen like FIG. 4 is displayed on the display unit 1, that is, in the case that the sub-screen is not displayed, when the red key 10R of the remote controller 10 is depressed, as illustrated in FIG. 5, a sub-screen 13 is superimposed on the main GUI screen and displayed at the lower right of the display unit 1.

The image displayed on the sub-screen 13 is not limited in particular, and may be, for example, contents (program) of the digital satellite broadcasting received by the antenna 143, contents of the digital terrestrial broadcasting received by the antenna 148, or an image according to the signals inputted to the line input terminal 137.

By the display of the sub-screen 13, it becomes impossible for a user to browse a part of the main GUI screen, more specifically, a lower right part of the web content area 11a. In such a case, the user may just depress the red key 10R again.

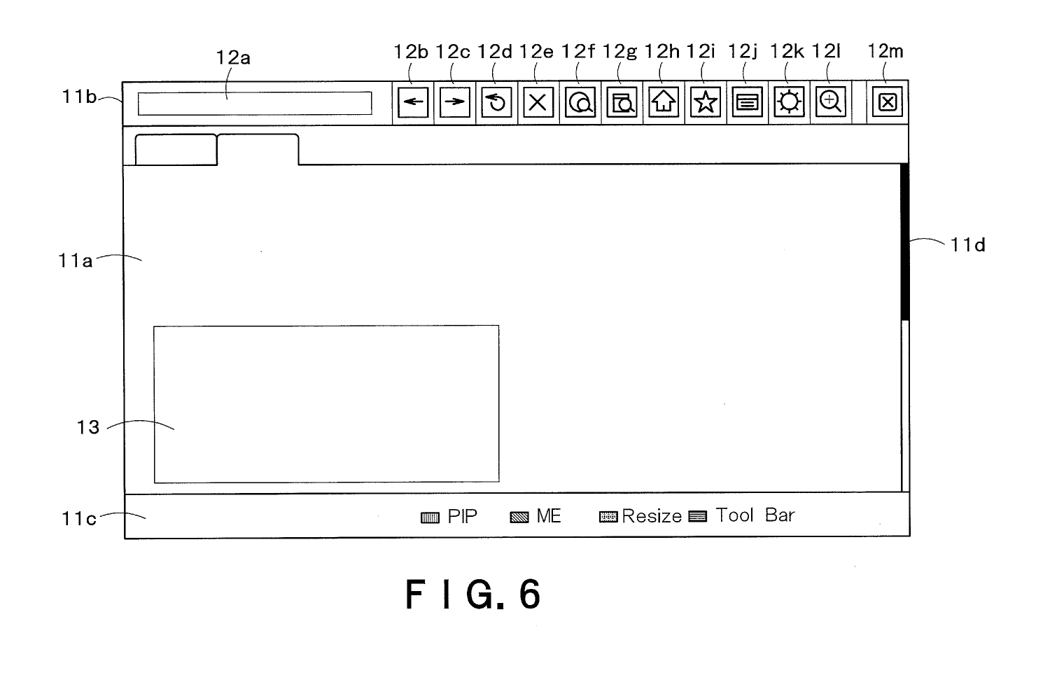

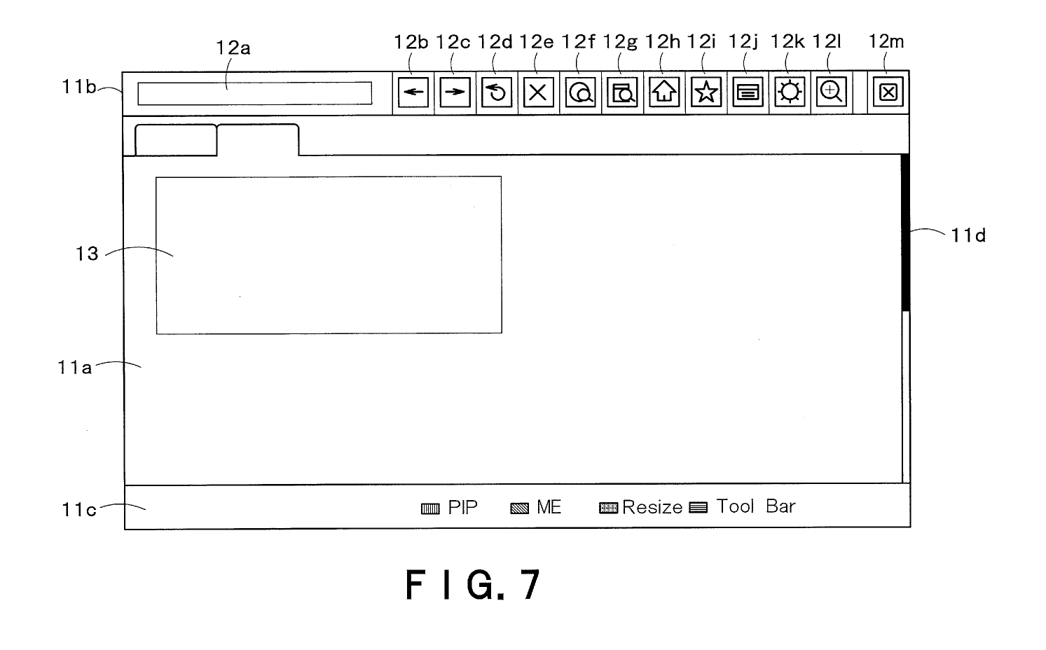

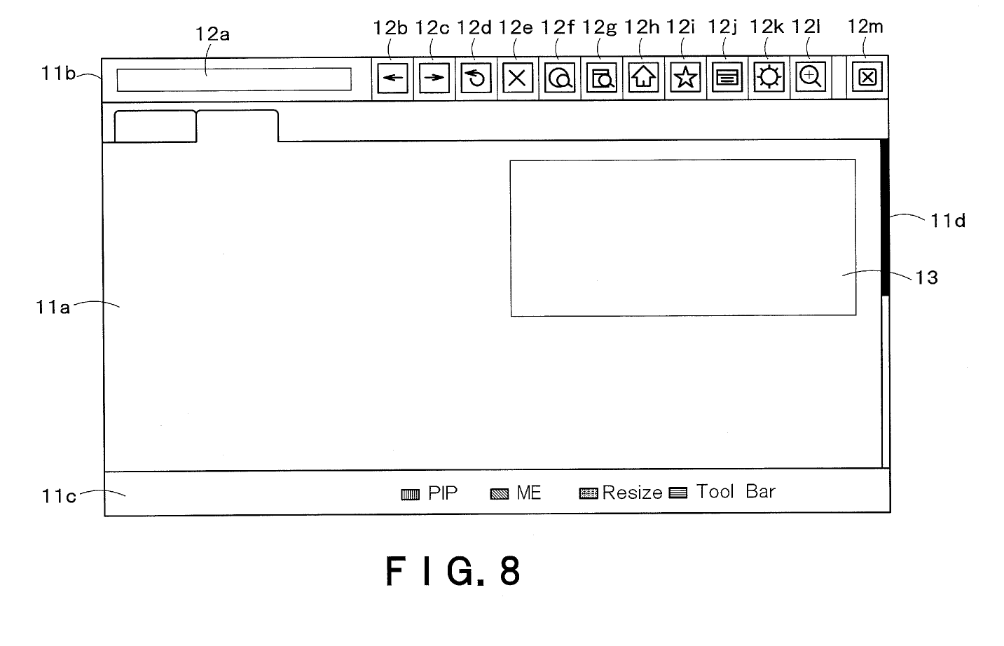

When the red key 10R is depressed in the state that the sub-screen 13 is displayed at the lower right of the screen, as illustrated in FIG. 6, the sub-screen 13 is moved to the lower left of the screen. Then, when the red key 10R is depressed in the state that the sub-screen 13 is displayed at the lower left of the screen, as illustrated in FIG. 7, the sub-screen 13 is moved to the upper left of the screen. Subsequently, when the red key 10R is depressed in the state that the sub-screen 13 is displayed at the upper left of the screen, as illustrated in FIG. 8, the sub-screen 13 is moved to the upper right of the screen. In such a manner, every time the red key 10R is depressed, the sub-screen 13 is moved and displayed at a different position. In other words, the display control unit 6 (described later) changes a display position of the sub-screen 13 when the sub-screen 13 is displayed on the display at a timing of an operation to the red key 10R.

Subsequently, when the red key 10R is depressed in the state that the sub-screen 13 is displayed at the upper right of the screen, the sub-screen 13 is hidden and the state of FIG. 4 returns.

The user may adjust the position of the sub-screen 13 as above so that the sub-screen 13 is not superimposed on the part that is desired to be browsed in the webpage.

Hereinafter, a processing operation of the display device 100 for achieving such display control of the sub-screen 13 will be described.

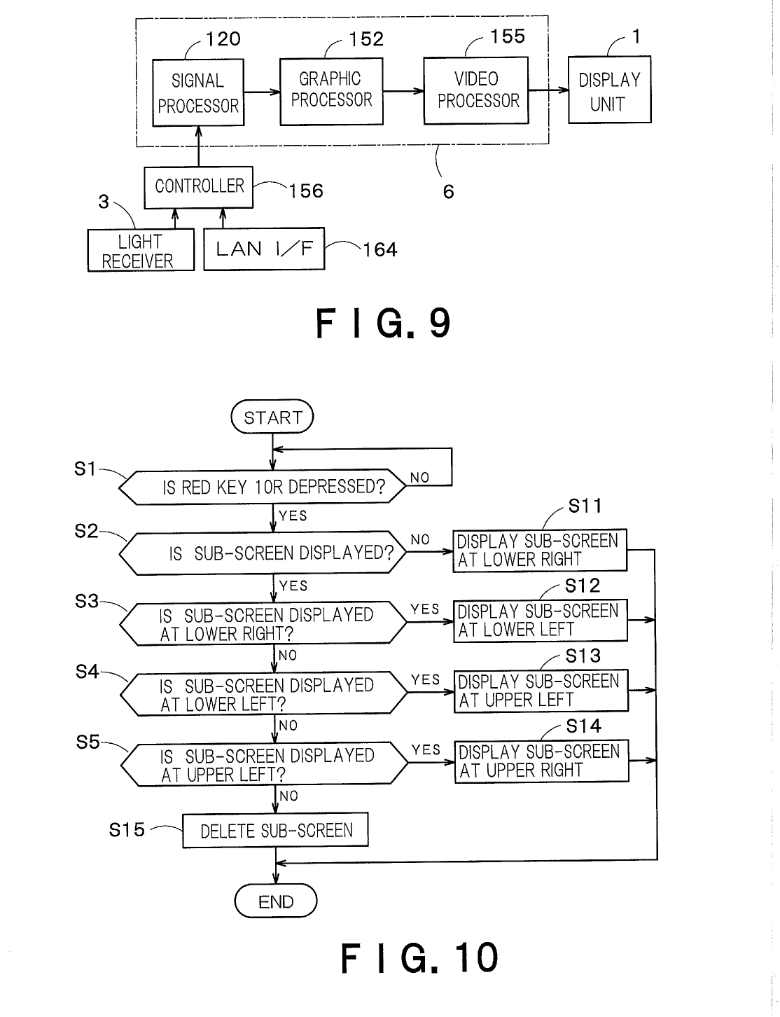

As illustrated in FIG. 9, for the display control of the sub-screen 13, among the individual units illustrated in FIG. 2, mainly the signal processor 120, the graphic processor 152, the video processor 155, the controller 156, the light receiver 3, and the LAN I/F 164 are used. In FIG. 9, the signal processor 120, the graphic processor 152, and the video processor 155 configure a display control unit (circuitry) 6. Then, the display control unit 6 may also be achieved by execution of a display program stored in the flash memory 160 in FIG. 2 by the CPU 159.

To the signal processor 120, the webpage acquired by the controller 156 through the LAN I/F 164 is inputted. Also, to the signal processor 120, content signals are inputted. The content signals are the signals selected by a user from digital satellite broadcasting wave signals received by the antenna 143, digital terrestrial broadcasting wave signals received by the antenna 148 and the signals inputted to the line input terminal 137, for example.

The light receiver 3 receives the control signals from the remote controller 10, and transmits them to the controller 156. When detecting that the red key 10R in the remote controller 10 is depressed, the controller 156 reports that effect to the signal processor 120.

The signal processor 120 generates signals for displaying the main GUI screen. Then, in response to an operation performed to the red key 10R, more specifically depression of the red key 10R, the signal processor 120 performs the following processing.

FIG. 10 is a flowchart illustrating one example of the processing operation of the signal processor 120 in the case that the red key 10R is depressed.

When the red key 10R is depressed (YES in step S1), the signal processor 120 determines whether or not the sub-screen 13 is currently displayed. In the case that the sub-screen 13 is not displayed (YES in step S2), the signal processor 120 generates video signals for displaying the sub-screen 13 at the lower right of the display unit 1 which is the initial position (step S11, FIG. 5). In other words, the display control unit 6 displays the sub-screen 13 at a first area on the display when the sub-screen is not displayed on the display at a timing of an operation to the red key 10R.

In the case that the sub-screen 13 is already displayed, when the position of the sub-screen 13 is the lower right (YES in step S3), the signal processor 120 moves the position of the sub-screen 13 to the lower left (step S12, FIG. 6). That is, the signal processor 120 generates video signals for displaying the sub-screen 13 at the lower left.

When the position of the sub-screen 13 is the lower left (YES in step S4), the signal processor 120 moves the position of the sub-screen 13 to the upper left (step S13, FIG. 7). That is, the signal processor 120 generates video signals for displaying the sub-screen 13 at the upper left.

When the position of the sub-screen 13 is the upper left (YES in step S5), the signal processor 120 moves the position of the sub-screen 13 to the upper right (step S14, FIG. 8). That is, the signal processor 120 generates video signals for displaying the sub-screen 13 at the upper right.

On the other hand, when the position of the sub-screen 13 is the upper right (NO in all steps S3-S5), the signal processor 120 deletes and hides the sub-screen 13 (step S15, FIG. 4). That is, the signal processor 120 generates video signals for not displaying the sub-screen 13 and displaying the main GUI screen. In other words, the display control unit 6 hides the sub-screen 13 when the sub-screen 13 is displayed at a certain position on the display at a timing of an operation to the red key 10R.

When giving descriptions from a different viewpoint, after the sub-screen 13 is displayed at the initial position, when the number of times of the depression of the red key 10R is 1 to 3, the signal processor 120 moves the display position of the sub-screen 13 in order. Then, when the number of times of the depression of the red key 10R reaches operating unit 4, the signal processor 120 deletes and hides the sub-screen 13.

Also, whether or not the sub-screen 13 is displayed, and what position it is displayed (or, how many times the red key 10R is depressed) can be discriminated by holding an internal variable inside the signal processor 120 for example.

Returning to FIG. 9, the video signals generated by the signal processor 120 are displayed at the display unit 1 through the graphic processor 152 and the video processor 155.

Assuming that the position of the sub-screen 13 can be moved only from the setting icon 12k of the sub-screen 13, it is needed to move the sub-screen 13 after the setting icon 12k is selected and the setting screen is displayed. As a result, a user is to operate the remote controller 10 for a plurality of times, and it is extremely troublesome for the user. In contrast, in the present embodiment, the user uses only the red key 10R to display the sub-screen 13 and to quickly move it to an appropriate position further.

In this way, in the present embodiment, the display, movement and hiding of the sub-screen 13 can be controlled using one red key 10R. Therefore, the user can easily control the sub-screen 13.

Also, the present embodiment has illustrated an example of displaying the sub-screen 13 at the lower right of the display unit 1 as the initial position and at the lower left, the upper left and the upper right thereafter and displaying the sub-screen 13 at four locations. However, the initial position, the display position and a display order of the sub-screen 13 are not limited in particular. Also, the initial position, the display position and/or the display order of the sub-screen 13 may be set by the user as well. Further, the size of the sub-screen 13 may be set by the user.

At least a part of the controller 5 described in the above-described embodiment may be configured by hardware or configured by software. In the case of configuring it by the software, a program that achieves at least a part of functions of the controller 5 may be stored in a recording medium such as a flexible disk or a CD-ROM, and be read and executed by a computer. The recording medium is not limited to a detachable one like a magnetic disk or an optical disk, and may be a fixed type recording medium such as a hard disk device or a memory.

Also, the program that achieves at least a part of functions of the controller 5 may be distributed through a communication line (including wireless communication) such as the Internet. Further, the program may be distributed through a wire circuit or a wireless circuit such as the Internet or by being stored in the recording medium, in the state of being encrypted, modulated or compressed.

While some embodiments of the present invention have been described, these embodiments have been presented as examples, and are not intended to limit the scope of the invention. These embodiments can be implemented in a variety of other forms, and various omissions, substitutions and changes can be made without departing from the spirit of the invention. These embodiments and modifications thereof are included in the invention described in the scope of claims and the equivalents as would be included in the scope and spirit of the invention.

### REFERENCE SIGNS LIST

1 Display unit
2 Speaker
3 Light receiver
4 Operating unit
5 Controller
6 Display control unit
10 Remote controller
13 Sub-screen
100 Display device

1. An electronic apparatus comprising:
a display configured to display a main-screen for displaying a web page and a sub-screen for displaying a content, wherein a display area of the main-screen and a display area of the sub-screen are at least partially overlapped; and
circuitry configured to:
display the sub-screen at a first area on the display when the sub-screen is not displayed on the display at a timing of an operation to a first key in a remote controller, and
change a display position of the sub-screen or hide the sub-screen when the sub-screen is displayed on the display at a timing of an operation to the first key in the remote controller.

2. The electronic apparatus of claim 1, wherein
the circuitry, after displaying the sub-screen at the first area,
displays the sub-screen at a different position when the number of operations performed to the first key is smaller than a first number, and
hides the sub-screen when the number of operations performed to the first key reaches the first number.

3. The electronic apparatus of claim 1, wherein
first to n-th (n is an integer equal to or larger than 2) display positions that are different from each other are set in the display, and
the circuitry moves a display position of the sub-screen in order of the first to n-th display positions every time an operation is performed to the first key, and hides the sub-screen when the operation is performed to the first key in the case that the sub-screen is displayed at the n-th display position.

4. The electronic apparatus of claim 1, wherein the first key is a key arranged at an end of the remote controller.

5. The electronic apparatus of claim 1, wherein the circuitry changes a size of the sub-screen in response to an operation performed to a second key in the remote controller.

6. The electronic apparatus of claim 1, wherein at least one of the first area to display the sub-screen, a display position of the sub-screen, a display order of the sub-screen, and a size of the sub-screen is settable.

7. The electronic apparatus of claim 1, wherein
the circuitry, in response to the operation performed to the first key,
displays the sub-screen at lower right of the display in the case that the sub-screen is not displayed on the display,
displays a position of the sub-screen at lower left in the case that the sub-screen is displayed at the lower right of the display,
displays the position of the sub-screen at upper left in the case that the sub-screen is displayed at the lower left of the display,
displays the position of the sub-screen at upper right in the case that the sub-screen is displayed at the upper left of the display, and
hides the sub-screen in the case that the sub-screen is displayed at the upper right of the display.

8. A display method in an electronic apparatus including a display configured to display a main-screen for displaying a web page and a sub-screen for displaying a content, wherein a display area of the main-screen and a display area of the sub-screen are at least partially overlapped, the display method comprising:
displaying the sub-screen at a first area on the display, in response to an operation performed to a first key in a remote controller, in the case that the sub-screen is not displayed on the display; and
displaying the sub-screen at a different position or hiding the sub-screen, in response to an operation performed to the first key, in the case that the sub-screen is displayed on the display.

9. The display method of claim 8, wherein,
after the sub-screen is displayed at the first area,
the sub-screen is displayed at a different position when the number of operations performed to the first key is smaller than a first number, and
the sub-screen is hidden when the number of operations performed to the first key reaches the first number.

10. The display method of claim 8, wherein
first to n-th (n is an integer equal to or larger than 2) display positions that are different from each other are set in the display, and
a display position of the sub-screen is moved in order of the first to n-th display positions every time an operation is performed to the first key, and the sub-screen is hidden when the operation is performed to the first key in the case that the sub-screen is displayed at the n-th display position.

11. The display method of claim 8, wherein the first key is a key arranged at an end of the remote controller.

12. The display method of claim 8, comprising
changing a size of the sub-screen in response to an operation performed to a second key in the remote controller.

13. The display method of claim 8, wherein at least one of the first area to display the sub-screen, a display position of the sub-screen, a display order of the sub-screen, and a size of the sub-screen is settable.

14. The display method of claim 8, comprising:
in response to an operation performed to the first key,
displaying the sub-screen at lower right of the display in the case that the sub-screen is not displayed on the display,
displaying a position of the sub-screen at lower left in the case that the sub-screen is displayed at the lower right of the display,
displaying the position of the sub-screen at upper left in the case that the sub-screen is displayed at the lower left of the display,
displaying the position of the sub-screen at upper right in the case that the sub-screen is displayed at the upper left of the display, and
hiding the display of the sub-screen in the case that the sub-screen is displayed at the upper right of the display.

15. A display program in an electronic apparatus including a display configured to display a main-screen for displaying a web page and a sub-screen for displaying a content, wherein a display area of the main-screen and a display area of the sub-screen are at least partially overlapped, the display program causing a computer to execute:
displaying the sub-screen at a first area on the display, in response to an operation performed to a first key in a remote controller, in the case that the sub-screen is not displayed on the display; and
displaying the sub-screen at a different position or hiding the sub-screen, in response to an operation performed to the first key, in the case that the sub-screen is displayed on the display.

16. The display program of claim 15, wherein,
after the sub-screen is displayed at the first area,
the sub-screen is displayed at a different position when the number of operations performed to the first key is smaller than a first number, and
the sub-screen is hidden when the number of operations performed to the first key reaches the first number.

17. The display program of claim 15, wherein
first to n-th (n is an integer equal to or larger than 2) display positions that are different from each other are set in the display, and
a display position of the sub-screen is moved in order of the first to n-th display positions every time an operation is performed to the first key, and the sub-screen is hidden when the operation is performed to the first key in the case that the sub-screen is displayed at the n-th display position.

18. The display program of claim 15, wherein the first key is a key arranged at an end of the remote controller.

19. The display program of claim 15, comprising
changing a size of the sub-screen in response to an operation performed to a second key in the remote controller.

20. The display program of claim 15, wherein at least one of the first area to display the sub-screen, a display position of the sub-screen, a display order of the sub-screen, and a size of the sub-screen is settable.
